(19) United States
(12) Patent Application Publication
(10) Pub. No.: US 2026/0163643 A1
(43) Pub. Date: Jun. 11, 2026

(54) OPTICAL TRANSCEIVER AND CONTROL METHOD THEREOF

(71) Applicant: Brillian Network & Automation Integrated System Co., Ltd., Miaoli County (TW)

(72) Inventor: CHIH-YI WANG, Miaoli County (TW)

(21) Appl. No.: 19/064,610

(22) Filed: Feb. 26, 2025

(30) Foreign Application Priority Data
Dec. 10, 2024 (TW) 113147774

(51) Int. Cl. H04B 10/40; H04B 10/079

(52) U.S. Cl. CPC H04B 10/40; H04B 10/07955

(57) ABSTRACT

An optical transceiver and a control method of the optical transceiver. The optical transceiver includes a light-receiving module, an optical transmitter, and a control circuit. The light-receiving module includes a plurality of optical receivers. The control circuit is connected to the light-receiving module and the optical transmitter. The control circuit receives a plurality of light-receiving signals obtained by the light-receiving module. According to a plurality of received signal strength indicator values that correspond to the light-receiving signals, one of the optical receivers is selectively used as a data receiving end for subsequent receipt of data sources.

### CROSS-REFERENCE TO RELATED PATENT APPLICATION

This application claims the benefit of priority to Taiwan Patent Application No. 113147774, filed on Dec. 10, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a transceiver, and more particularly to an optical transceiver that involves optical transmission and a control method thereof.

### BACKGROUND OF THE DISCLOSURE

Conventionally, existing optical transceivers include a single optical receiver and a single optical transmitter. However, in a semiconductor factory, a considerable amount of mobile apparatuses are mounted with the optical transceivers to act as a signal transmission medium, and an error can occur when each of the mobile apparatuses arrives at a work area, thereby preventing one optical transceiver from being accurately aligned with another optical transceiver.

### SUMMARY OF THE DISCLOSURE

In response to the above-referenced technical inadequacy, the present disclosure provides an optical transceiver and a control method thereof.

In order to solve the above-mentioned problem, one of the technical aspects adopted by the present disclosure is to provide an optical transceiver, which includes a light-receiving module, an optical transmitter, and a control circuit. The light-receiving module includes a plurality of optical receivers. The control circuit is connected to the light-receiving module and the optical transmitter. The control circuit receives a plurality of light-receiving signals obtained by the light-receiving module, and outputs a setting signal according to a plurality of received signal strength indicator values that correspond to the light-receiving signals, so as to selectively use one of the optical receivers as a data receiving end for subsequent receipt of data sources.

In order to solve the above-mentioned problem, another one of the technical aspects adopted by the present disclosure is to provide a control method of an optical transceiver. The control method includes: obtaining a plurality of light-receiving signals by a plurality of optical receivers of a light-receiving module of the optical transceiver; determining a plurality of received signal strength indicator values that correspond to the light-receiving signals; and selectively using, according to a determination result, one of the optical receivers as a data receiving end for subsequent receipt of data sources.

Therefore, in the optical transceiver and the control method thereof provided by the present disclosure, a signal transmission accuracy for aligning the optical transceiver with a target device can be improved by the optical receivers in the optical transceiver.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of an architecture of an optical transceiver system according to one embodiment of the present disclosure;

FIG. 2 is a circuit block diagram of an optical transceiver according to one embodiment of the present disclosure;

FIG. 3 is a flowchart of a control method of the optical transceiver according to one embodiment of the present disclosure;

FIG. 4A and FIG. 4B are each a flowchart of the control method of the optical transceiver according to one embodiment of the present disclosure;

FIG. 5A to FIG. 5C are each a schematic distribution diagram of optical receivers and an optical transmitter of the optical transceiver according to one embodiment of the present disclosure; and

FIG. 6 is a schematic diagram of an architecture of an automatic transport system according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

Embodiments of the present disclosure provide an optical transceiver and a control method thereof. The optical transceiver mentioned herein is an integration of a plurality of optical receivers and a single optical transmitter, and the optical transmitter is disposed between the optical receivers. Through different received signal strength indicator (RSSI) values obtained by the optical receivers at different positions, relative positions of the optical transceiver and a target device (e.g., another optical transceiver) can be identified, and whether or not the optical transceiver is aligned with the target device can be further determined. Moreover, when the optical transceiver is not aligned with the target device, adjustment can be made to an optical emission power of the optical transceiver, so as to enable the target device to more smoothly receive output data of the optical transceiver. The inclusion of more than one optical receiver allows a signal transmission accuracy for aligning the optical transceiver with the target device to be effectively improved.

### Embodiment of Operational Architecture of an Optical Transceiver System and the Optical Transceiver

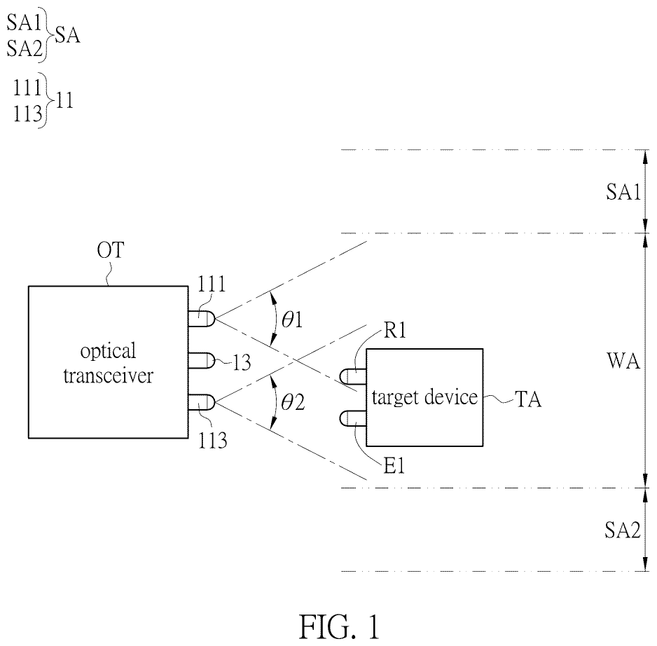

Reference is made to FIG. 1, which is a schematic diagram of an architecture of an optical transceiver system according to one embodiment of the present disclosure. In the optical transceiver system of the present embodiment, an optical signal is used as a transmission medium between an optical transceiver OT and a target device TA. It should be noted that the optical transceiver OT includes a light-receiving module 11 (which includes a plurality of optical receivers) and an optical transmitter 13. For convenience of illustration, a quantity of the optical receivers of the light-receiving module 11 in the optical transceiver OT is exemplified as being two, the optical transceiver OT is exemplified to be a fixed device, and the target device TA is exemplified to be a mobile device, but the present disclosure is not limited thereto. In other embodiments, the optical transceiver OT can be the mobile device, and the target device TA can be the fixed device.

As shown in FIG. 1, a first optical receiver 111 and a second optical receiver 113 of the optical transceiver OT are disposed on two sides of the optical transmitter 13, respectively. A distance between each of the optical receivers and the optical transmitter 13 is less than a distance between any two of the optical receivers. The first optical receiver 111 has a first light-receiving angle θ1, and the second optical receiver 113 has a second light-receiving angle θ2. In addition, a cover area of the first light-receiving angle θ1 and a cover area of the second light-receiving angle θ2 partially overlap with each other. On the other hand, the target device TA is similarly exemplified to be a target optical transceiver. The target optical transceiver includes an optical transmitter E1 and an optical receiver R1, and is moved to an area as shown in FIG. 1.

In one embodiment, the optical transceiver OT as shown in FIG. 1 determines a work area WA of the target device TA according to placement positions of the optical receivers. For example, when the target device TA is positioned in the work area WA, the optical transceiver OT is indicated as being accurately aligned with the target device TA. Therefore, data can be successfully transmitted between the optical transceiver OT and the target device TA. For example, the optical transceiver OT can receive output data of the target device TA, or the target device TA can receive output data of the optical transceiver OT.

In one embodiment, when the target device TA is not positioned in the work area WA but is positioned in a sensing area SA (e.g., a first sensing area SA1 or a second sensing area SA2), the optical transceiver OT is indicated as being slightly away from a position for accurate alignment with the target device TA. The optical transceiver OT can increase an emission power of the optical transmitter 13, such that the chance of the target device TA successfully obtaining the output data of the optical transceiver OT is enhanced.

In one embodiment, when the target device TA is not positioned in the work area WA and the sensing area SA, the optical transceiver OT is indicated as being far from the position for accurate alignment with the target device TA. At this time, the optical transceiver OT fails to perform accurate signal transmission with the target device TA.

It should be noted that, according to a plurality of light-receiving signals obtained by the optical receivers and a plurality of received signal strength indicator values that correspond to the light-receiving signals, the optical transceiver OT can identify its position relative to the target device TA.

For example, when the received signal strength indicator values obtained by the optical transceiver OT are each less than a first predetermined value, the target device TA is indicated as being positioned in an area outside of the work area WA and the sensing area SA at this time. When the received signal strength indicator values obtained by the optical transceiver OT are each greater than the first predetermined value, but a difference of any two of the received signal strength indicator values is greater than a second predetermined value, the target device TA is indicated as being positioned in the sensing area SA (e.g., the first sensing area SA1 or the second sensing area SA2) at this time. When the received signal strength indicator values obtained by the optical transceiver OT are each greater than the first predetermined value, but the difference of any two of the received signal strength indicator values is less than the second predetermined value, the target device TA is indicated as being positioned in the work area WA at this time.

In one embodiment, when the target device TA is positioned in the work area WA, the optical transceiver OT can further determine one of the optical receivers as a data receiving end. For example, the received signal strength indicator value of the optical receiver that is used as the data receiving end is greater than the first predetermined value, and is a maximum one of the received signal strength indicator values. After the data receiving end is determined, the optical transceiver OT subsequently sets this data receiving end to receive the output data of the target device TA. The output data of the target device TA is, for example, optical output data of the optical transmitter E1 of the target optical transceiver.

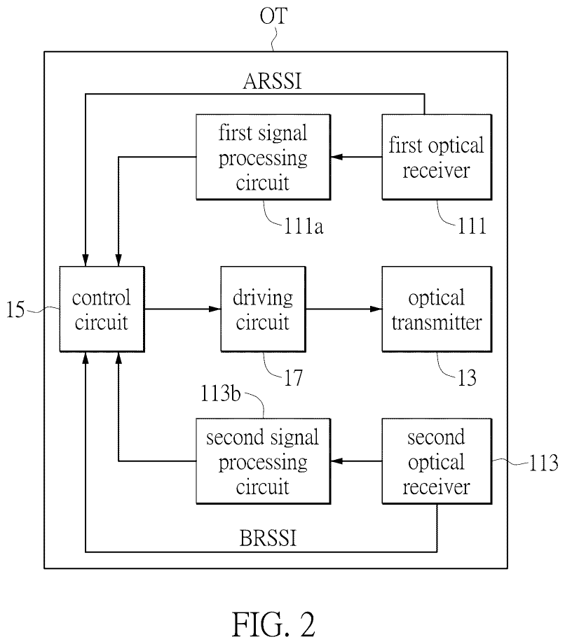

Reference is made to FIG. 2, which is a circuit block diagram of the optical transceiver according to one embodiment of the present disclosure. The optical transceiver OT as shown in FIG. 2 includes a control circuit 15, a driving circuit 17, a first signal processing circuit 111a, a second signal processing circuit 113b, the first optical receiver 111, the second optical receiver 113, and the optical transmitter 13, but is not limited thereto. The control circuit 15 is connected to the driving circuit 17, the first signal processing circuit 111a, the second signal processing circuit 113b, the first optical receiver 111, and the second optical receiver 113. The driving circuit 17 is connected to the optical transmitter 13. The first signal processing circuit 111a is connected to the first optical receiver 111, and the second signal processing circuit 113b is connected to the second optical receiver 113.

In one embodiment, the control circuit 15 controls the emission power of the optical transmitter 13 via the driving circuit 17. The control circuit 15 obtains a first received signal strength indicator value ARSSI via the first optical receiver 111, and obtains a second received signal strength indicator value BRSSI via the second optical receiver 113. The control circuit 15 obtains light-receiving signals of the first optical receiver 111 and the second optical receiver 113 via the first signal processing circuit 111a and the second signal processing circuit 113b, respectively.

For example, the first optical receiver 111 and the second optical receiver 113 are each a photodiode (PD) for converting the optical signal into a photocurrent. The first signal processing circuit 111a and the second signal processing circuit 113b are each a transimpedance amplifier (TIA) for converting the photocurrent into a voltage signal. Then, the voltage signal is amplified by a limiting amplifier (LA) to an extent that allows the subsequent control circuit 15 to read a strength and a message of a signal. The detailed architectures of the first optical receiver 111, the second optical receiver 113, the first signal processing circuit 111a, and the second signal processing circuit 113b are known to those skilled in the art, and will not be reiterated herein.

It should be noted that, according to relative magnitude of the obtained first received signal strength indicator value ARSSI and second received signal strength indicator value BRSSI, the control circuit 15 can identify relative positions of the target device TA and the optical transceiver OT. According to the relative positions, the control circuit 15 further determines whether or not the optical transceiver OT can successfully receive the output data of the target device TA.

Specifically, when the control circuit 15 determines that the first received signal strength indicator value ARSSI and the second received signal strength indicator value BRSSI are each less than the first predetermined value, the control circuit 15 considers the target device TA to be not positioned in an alignment range of the optical transceiver OT at this time. When the control circuit 15 determines that the first received signal strength indicator value ARSSI and the second received signal strength indicator value BRSSI are each greater than the first predetermined value, and determines that a difference of the first received signal strength indicator value ARSSI and the second received signal strength indicator value BRSSI is less than the second predetermined value, the control circuit 15 considers the target device TA to be positioned in the alignment range of the optical transceiver OT. That is, at this time, the target device TA is positioned in the work area WA as shown in FIG. 1.

In one embodiment, when the target device TA is positioned in the work area WA as shown in FIG. 1, the control circuit 15 selects the optical receiver that can receive the maximum one of the received signal strength indicator values as the data receiving end. For example, when the first received signal strength indicator value ARSSI is greater than the second received signal strength indicator value BRSSI, the control circuit 15 outputs a setting signal to select the first optical receiver 111 as the data receiving end. When the second received signal strength indicator value BRSSI is greater than the first received signal strength indicator value ARSSI, the control circuit outputs the setting signal to select the second optical receiver 113 as the data receiving end. Suppose the first received signal strength indicator value ARSSI is equal to the second received signal strength indicator value BRSSI, the control circuit 15 can freely select one of the first optical receiver 111 and the second optical receiver 113 as the data receiving end.

The setting signal mentioned herein is, for example, a read signal. For example, the control circuit 15 sends the read signal to the first signal processing circuit 111a, so as to obtain the light-receiving signal received by the first optical receiver 111. Alternatively, the control circuit 15 sends the read signal to the second signal processing circuit 113b, so as to obtain the light-receiving signal received by the second optical receiver 113.

In one embodiment, when the target device TA is not positioned in the work area WA as shown in FIG. 1 but is positioned in the sensing area SA (e.g., the first sensing area SA1 or the second sensing area SA2), the control circuit 15 outputs a power adjustment signal to the driving circuit 17, and the driving circuit 17 controls the emission power of the optical transmitter 13 according to this power adjustment signal. For example, the power adjustment signal mentioned herein is used for controlling the emission power of the optical transmitter 13 to be increased.

In one embodiment, when the target device TA is positioned in the sensing area SA, and the optical transceiver OT fails to receive the output data of the target device TA after the control circuit 15 outputs the power adjustment signal multiple times within a predetermined time, the control circuit 15 can output a warning signal to a warning device. The warning signal mentioned herein is, for example, any combination of a voice signal, a light signal, or a text signal. In addition, according to a shift in position of the target device TA relative to the optical transceiver OT, a corresponding warning signal can be output.

For example, when the first received signal strength indicator value ARSSI is greater than the second received signal strength indicator value BRSSI, the warning signal at this time is a warning signal indicating proximity between the target device TA and the first optical receiver 111. When the second received signal strength indicator value BRSSI is greater than the first received signal strength indicator value ARSSI, the warning signal at this time is a warning signal indicating proximity between the target device TA and the second optical receiver 113.

### Embodiment of Control Method of the Optical Transceiver

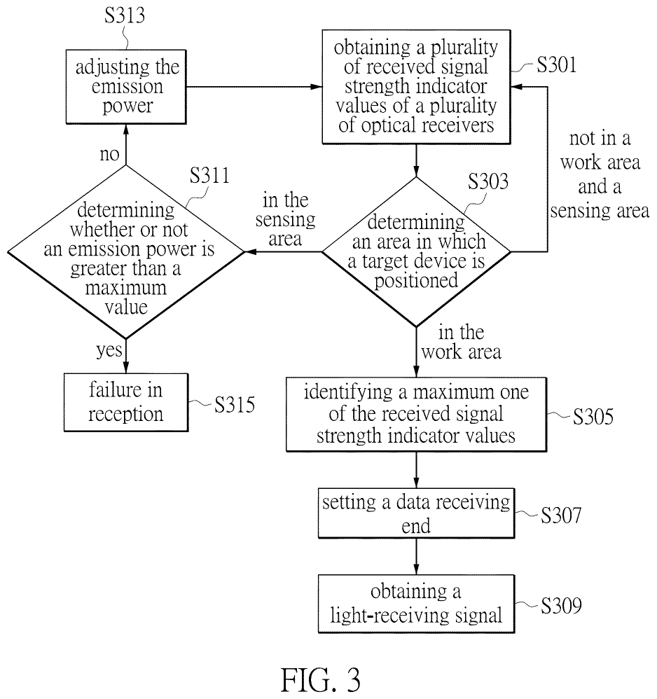

Reference is made to FIG. 3, which is a flowchart of the control method of the optical transceiver according to one embodiment of the present disclosure. The flowchart of FIG. 3 includes, for example but not limited to, the following steps. Reference can also be made to the optical transceiver of the above-mentioned embodiment.

Step S301: obtaining the received signal strength indicator values of the optical receivers. During data transmission, the optical transceiver OT needs to be aligned with the target device TA. The light-receiving module 11 of the optical transceiver OT can receive the output data of the target device TA. For example, each optical receiver of the light-receiving module 11 obtains one light-receiving signal, and a corresponding received signal strength indicator value can be obtained from said light-receiving signal.

Step S303: determining an area in which the target device is positioned. When the control circuit 15 determines that the received signal strength indicator values are each less than the first predetermined value, the target device TA is determined to be not positioned in the work area WA and the sensing area SA, and the control method returns to step S301 for further execution. When the received signal strength indicator values are each greater than the first predetermined value, the control circuit 15 of the optical transceiver OT further determines whether or not the difference of any two of the received signal strength indicator values is less the second predetermined value. If the difference of any two of the received signal strength indicator values is less the second predetermined value, the target device TA is determined to be positioned in the work area WA, and then step S305 is executed. If the difference of any two of the received signal strength indicator values is not less the second predetermined value, the target device TA is determined to be positioned in the sensing area SA, and then step S311 is executed.

Step S305: identifying the maximum one of the received signal strength indicator values. When the target device TA is positioned in the work area WA, the control circuit 15 identifies the maximum one of the received signal strength indicator values.

Step S307: setting the data receiving end. The control circuit 15 sets the optical receiver receiving the maximum one of the received signal strength indicator values as the data receiving end.

Step S309: obtaining the light-receiving signal. The control circuit 15 obtains the light-receiving signal from the data receiving end.

Step S311: determining whether or not the emission power is greater than a maximum value. The control circuit 15 determines whether or not the emission power of the optical transmitter 13 in the optical transceiver OT is adjusted to the maximum value. If the determination is negative in step S311, the control method proceeds to step S313. If the determination is positive in step S311, the control method proceeds to step S315.

Step S313: adjusting the emission power. When the target device TA is positioned in the sensing area SA, the control circuit 15 controls the emission power of the optical transmitter 13 in the optical transceiver OT. For example, the control circuit 15 can increase the emission power of the optical transmitter 13.

Step S315: failure in reception. The control circuit 15 considers optical reception and transmission between the optical transceiver OT and the target device TA impossible, thereby leading to failure in reception.

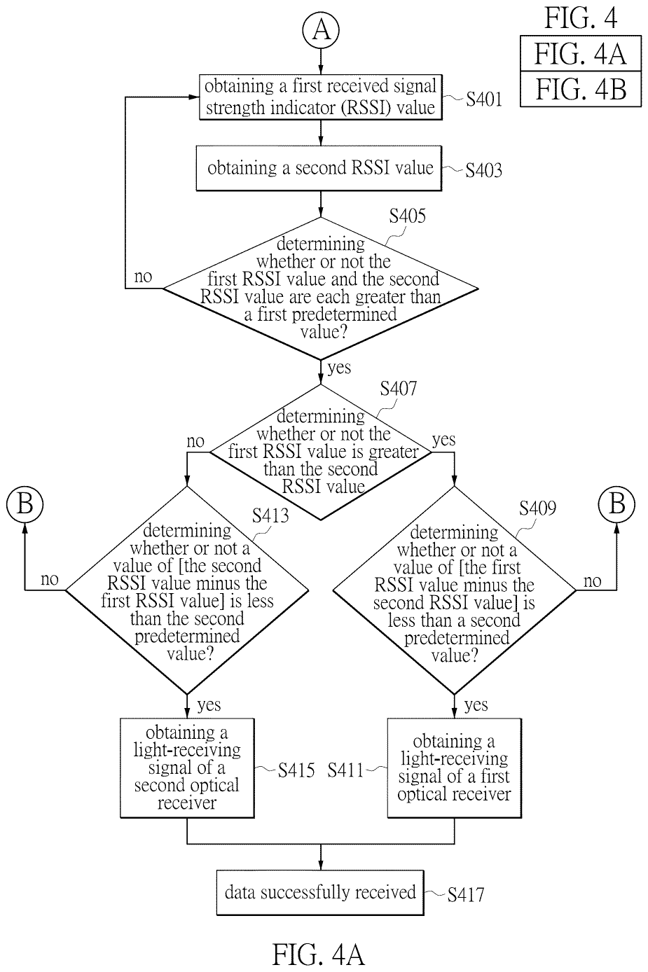

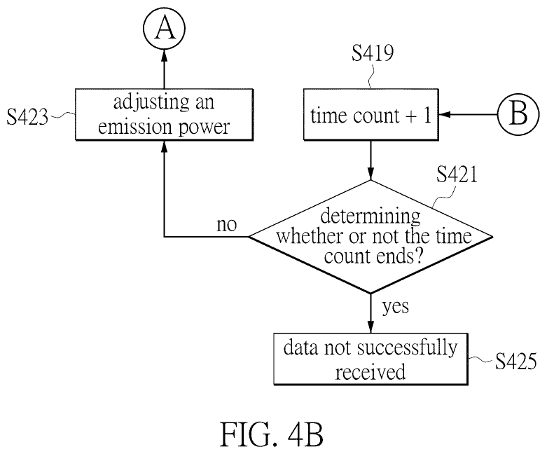

Reference is made to FIG. 4A and FIG. 4B, which are each a flowchart of the control method of the optical transceiver according to one embodiment of the present disclosure. The flowcharts of FIG. 4A and FIG. 4B include, for example but not limited to, the following steps. Reference can also be made to the optical transceiver of the above-mentioned embodiment.

Step S401: obtaining the first received signal strength indicator value ARSSI when the optical signal is transmitted between the optical transceiver OT and the target device TA. Here, the control circuit 15 obtains the first received signal strength indicator value ARSSI of the light-receiving signal received by the first optical receiver 111.

Step S403: obtaining the second received signal strength indicator value BRSSI. Here, the control circuit 15 of the optical transceiver OT obtains the second received signal strength indicator value BRSSI of the light-receiving signal received by the second optical receiver 113.

Step S405: determining whether or not the first received signal strength indicator value ARSSI and the second received signal strength indicator value BRSSI are each greater than the first predetermined value. By determining a magnitude of each of the first received signal strength indicator value ARSSI and the second received signal strength indicator value BRSSI, the control circuit 15 can identify whether or not the target device TA is positioned outside of the work area WA and the sensing area SA. When the determination is positive in step S405, the target device TA is indicated as being positioned in the work area WA or the sensing area SA, and the control method proceeds to step S407. When the determination is negative in step S405, the target device TA is indicated as being positioned outside of the work area WA and the sensing area SA, and the control method returns to step S401.

Step S407: determining whether or not the first received signal strength indicator value ARSSI is greater than the second received signal strength indicator value BRSSI. Through execution of step S407, the control circuit 15 identifies whether the target device TA is adjacent to the first optical receiver 111 or the second optical receiver 113. When the determination is positive in step S407, the target device TA is indicated as being adjacent to the first optical receiver 111, and the control method proceeds to step S409. When the determination is negative in step S407, the target device TA is indicated as being adjacent to the second optical receiver 113, and the control method proceeds to step S413.

Step S409: determining whether or not a value of [the first received signal strength indicator value ARSSI minus the second received signal strength indicator value BRSSI] is less than the second predetermined value. According to an execution result of step S409, whether the target device TA is positioned in the work area WA or the sensing area SA can be identified by the control circuit 15. When the determination is positive in step S409, the target device TA is indicated as being positioned in the work area WA, and the control method proceeds to step S411. When the determination is negative in step S409, the target device TA is indicated as being positioned in the sensing area SA (e.g., the first sensing area SA1), and the control method proceeds to step S419.

Step S411: obtaining the light-receiving signal of the first optical receiver 111. When the target device TA is positioned in the work area WA, the control circuit 15 sets the first optical receiver 111 as the data receiving end, and directly receives the output data of the target device TA by the first optical receiver 111.

Step S413: determining whether or not a value of [the second received signal strength indicator value BRSSI minus the first received signal strength indicator value ARSSI] is less than the second predetermined value. According to an execution result of step S413, whether the target device TA is positioned in the work area WA or the sensing area SA can be identified by the control circuit 15. When the determination is positive in step S413, the target device TA is indicated as being positioned in the work area WA, and the control method proceeds to step S415. When the determination is negative in step S413, the target device TA is indicated as being positioned in the sensing area SA (e.g., the second sensing area SA2), and the control method proceeds to step S419.

Step S415: obtaining the light-receiving signal of the second optical receiver 113. When the target device TA is positioned in the work area WA, the control circuit 15 sets the second optical receiver 113 as the data receiving end, and directly receives the output data of the target device TA by the second optical receiver 113.

Step S417: data successfully received.

Step S419: time count+1.

Step S421: determining whether or not the time count ends. The control circuit 15 determines whether or not the time count reaches the predetermined time. When the determination is positive in step S421, the control method proceeds to step S425. When the determination is negative in step S421, the control method proceeds to step S423.

Step S423: adjusting the emission power. The control circuit 15 controls the emission power of the optical transmitter 13 in the optical transceiver OT. For example, the control circuit 15 can increase the emission power of the optical transmitter 13.

Step S425: data not successfully received.

In one embodiment, the control circuit 15 increases the emission power of the optical transmitter 13 according to the difference of the first received signal strength indicator value ARSSI and the second received signal strength indicator value BRSSI. For example, an increment value of the emission power is directly proportional to the difference of the first received signal strength indicator value ARSSI and the second received signal strength indicator value BRSSI.

In one embodiment, when the optical transceiver OT determines that the data is not successfully received, the control circuit 15 can output the warning signal to the warning device or other external devices for reminding the related personnel that optical reception and transmission between the optical transceiver OT and the target device TA is currently not possible (which leads to failure in data reception).

### Embodiment of Various Implementations of the Optical Receivers in the Optical Transceiver

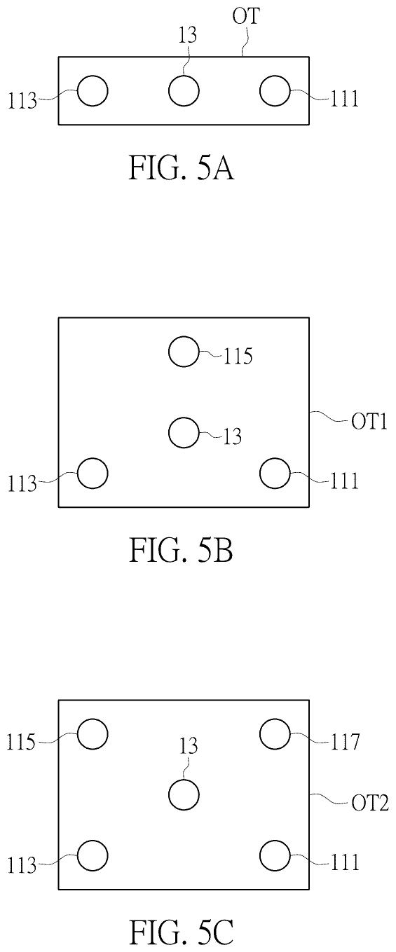

Reference is made to FIG. 5A to FIG. 5C, which are each a schematic distribution diagram of the optical receivers and the optical transmitter of the optical transceiver according to one embodiment of the present disclosure. Referring to FIG. 5A, the quantity of the optical receivers in a light-receiving module as shown in FIG. 5A is exemplified as being two, and the first optical receiver 111 and the second optical receiver 113 are respectively disposed on the two sides of the optical transmitter 13. For example, the first optical receiver 111, the optical transmitter 13, and the second optical receiver 113 are arranged in a straight line. In addition, a distance between the first optical receiver 111 and the second optical receiver 113 is greater than a distance between the optical transmitter 13 and the first optical receiver 111 or the second optical receiver 113. In other embodiments, the distance between the optical transmitter 13 and each of the first optical receiver 111 and the second optical receiver 113 is the same.

Referring to FIG. 5B, the quantity of the optical receivers in a light-receiving module as shown in FIG. 5B is three, and the optical transmitter 13 of an optical transceiver OT1 is positioned in a triangular area (or range) formed by the first optical receiver 111, the second optical receiver 113, and a third optical receiver 115. A distance between any two adjacent ones of the first optical receiver 111, the second optical receiver 113, and the third optical receiver 115 is greater than a distance between the optical transmitter 13 and the first optical receiver 111, the second optical receiver 113, or the third optical receiver 115. For example, the distance between the first optical receiver 111 and the second optical receiver 113 is greater than the distance between the first optical receiver 111 and the optical transmitter 13. In other embodiments, the optical transmitter 13 is positioned at a center of the triangular area (or range) formed by the first optical receiver 111, the second optical receiver 113, and the third optical receiver 115.

Referring to FIG. 5C, the quantity of the optical receivers in a light-receiving module as shown in FIG. 5C is exemplified as being four. The optical transmitter 13 of an optical transceiver OT2 is positioned in a quadrilateral range formed by the first optical receiver 111, the second optical receiver 113, the third optical receiver 115, and a fourth optical receiver 117. A distance between any two adjacent ones of the first optical receiver 111, the second optical receiver 113, the third optical receiver 115, and the fourth optical receiver 117 is greater than a distance between the optical transmitter 13 and the first optical receiver 111, the second optical receiver 113, the third optical receiver 115, or the fourth optical receiver 117. For example, the distance between the second optical receiver 113 and the third optical receiver 115 is greater than the distance between the first optical receiver 111 and the optical transmitter 13. In other embodiments, the optical transmitter 13 is positioned at a center of the quadrilateral range formed by the first optical receiver 111, the second optical receiver 113, the third optical receiver 115, and the fourth optical receiver 117.

Based on FIG. 5A to FIG. 5C as mentioned above, when the optical transceiver OT is aligned with the target device TA in an arrangement manner as shown in FIG. 5A, a relative change in distance of the target device TA with respect to the optical transceiver OT in a planar space can be identified. When the optical transceiver OT1 and the optical transceiver OT2 are aligned with the target device TA in an arrangement manner as shown in FIG. 5B or FIG. 5C, the relative change in distance of the target device TA with respect to the optical transceiver OT1 and the optical transceiver OT2 can be identified.

### Embodiment of Application of the Optical Transceiver in a Mobile Apparatus

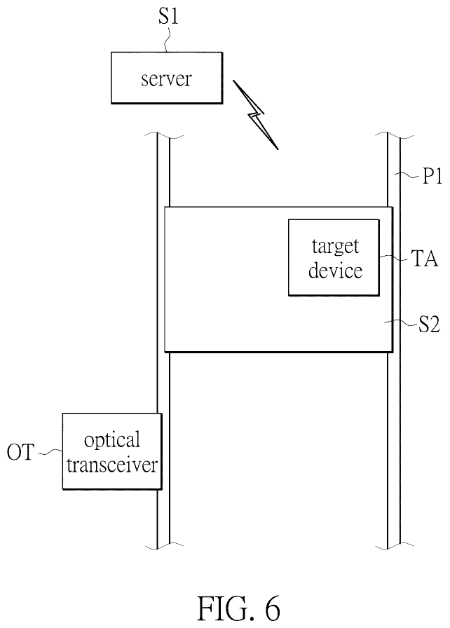

Reference is made to FIG. 6, which is a schematic diagram of an architecture of an automatic transport system according to one embodiment of the present disclosure. A mobile electronic apparatus S2 that carries the target device TA is exemplified to be an automatic unmanned transport vehicle that drives on a track P1, such as an overhead hoist transport (OHT). The optical transceiver OT is disposed at a designated position on the track P1. Based on a transport mission from a server S1, the electronic apparatus S2 can automatically move to the designed position on the track P1 for loading or unloading. When the electronic apparatus S2 moves to the designated position, the optical transceiver OT needs to be aligned with the target device TA of the electronic apparatus S2, so as to facilitate communication between the optical transceiver OT and the target device TA through data transmission. As to how the optical transceiver OT determines whether or not its alignment with the target device TA is accurate, reference can be made to the above-mentioned embodiment.

In one embodiment, when failure in data reception occurs due to the optical transceiver OT not being aligned with the target device TA, the optical transceiver OT can further output the warning signal and a code name of the target device TA to the server S1, thereby enabling the server S1 to record and analyze a working status of the optical transceiver OT. The working status can be information about the shift in position when the optical transceiver OT and the target device TA fail to be aligned with each other, such as the target device TA being adjacent to a specific one of the optical receivers in the optical transceiver OT, or statistics about the shift in position of target devices TA under different code names and the optical transceiver OT.

In one embodiment, the control circuit 15 can be, for example, one or any combination of an application-specific integrated circuit (ASIC), a field-programmable gate array (FPGA), a digital signal processor (DSP), and a system on a chip (SoC). The control circuit 15 can cooperate with other related circuit components and firmware to implement the above-mentioned functional processes.

In one embodiment, the range of the work area WA is determined by a light-emitting angle of each optical receiver in the light-receiving module 11. A light-receiving angle of the optical receiver can be, for example but not limited to, 10 or 20 degrees, and can be flexibly adjusted according to practical requirements. As for preferred alignment positions of the optical transceiver and the target device, the optical transmitter 13 of the optical transceiver OT is arranged to be aligned with the optical transmitter E1 of the target device TA.

### Beneficial Effects of the Embodiments

In conclusion, in the optical transceiver and the control method thereof provided by the present disclosure, the optical transceiver integrates the optical receivers to enlarge a work area of the target device, thereby allowing the optical transceiver to easily receive a signal of the target device and improving a signal transmission accuracy for aligning the optical transceiver with the target device.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optical transceiver, comprising:
a light-receiving module including a plurality of optical receivers;
an optical transmitter; and
a control circuit connected to the light-receiving module and the optical transmitter;
wherein the control circuit receives a plurality of light-receiving signals obtained by the light-receiving module, and outputs a setting signal according to a plurality of received signal strength indicator values that correspond to the plurality of light-receiving signals, so as to selectively use one of the plurality of optical receivers as a data receiving end for subsequent receipt of data sources.

2. The optical transceiver according to claim 1, wherein the received signal strength indicator value of the optical receiver that is used as the data receiving end is greater than a first predetermined value, and is a maximum one of the plurality of received signal strength indicator values.

3. The optical transceiver according to claim 2, wherein a difference of the received signal strength indicator value of the optical receiver that is used as the data receiving end and the received signal strength indicator value of any one of the plurality of optical receivers that is not used as the data receiving end is less than a second predetermined value.

4. The optical transceiver according to claim 3, wherein the control circuit outputs a power adjustment signal to increase an emission power of the optical transmitter, such that any one of the plurality of received signal strength indicator values is greater than the first predetermined value.

5. The optical transceiver according to claim 3, wherein the control circuit outputs a power adjustment signal to increase an emission power of the optical transmitter, such that a difference of any two of the plurality of received signal strength indicator values is less than the second predetermined value.

6. The optical transceiver according to claim 5, wherein, when the control circuit fails to identify the data receiving end by the plurality of received signal strength indicator values that correspond to the plurality of light-receiving signals within a predetermined time, the control circuit outputs a warning signal.

7. The optical transceiver according to claim 1, wherein a distance between each of the plurality of optical receivers and the optical transmitter is less than a distance between any two of the plurality of optical receivers.

8. The optical transceiver according to claim 7, wherein the light-receiving module includes a first optical receiver and a second optical receiver, and the optical transmitter, the first optical receiver, and the second optical receiver are arranged in a straight line.

9. The optical transceiver according to claim 7, wherein the light-receiving module includes a first optical receiver, a second optical receiver, and a third optical receiver, and the optical transmitter is positioned in a triangular area formed by the first optical receiver, the second optical receiver, and the third optical receiver.

10. The optical transceiver according to claim 1, further comprising a driving circuit, wherein the driving circuit is connected to the control circuit and the optical transmitter, and the control circuit outputs a power adjustment signal to the driving circuit, such that the driving circuit controls an emission power of the optical transmitter according to the power adjustment signal.

11. A control method of an optical transceiver, comprising:
obtaining a plurality of light-receiving signals by a plurality of optical receivers of a light-receiving module of the optical transceiver;
determining a plurality of received signal strength indicator values that correspond to the plurality of light-receiving signals; and
selectively using, according to a determination result, one of the plurality of optical receivers as a data receiving end for subsequent receipt of data sources.

12. The control method according to claim 11, further comprising:
determining whether or not the plurality of received signal strength indicator values are each greater than a first predetermined value;
wherein, in response to determining that the plurality of received signal strength indicator values are each greater than the first predetermined value, the optical receiver having a maximum one of the plurality of received signal strength indicator values is used as the data receiving end;
wherein, in response to determining that any one of the plurality of received signal strength indicator values is less than the first predetermined value, an emission power of an optical transmitter of the optical transceiver is increased.

13. The control method according to claim 12, further comprising:
determining, when the plurality of received signal strength indicator values are each greater than the first predetermined value, whether or not a difference of any two of the plurality of received signal strength indicator values is greater than a second predetermined value;
wherein, in response to determining that the difference of any two of the plurality of received signal strength indicator values is not greater than the second predetermined value, the optical receiver having the maximum one of the plurality of received signal strength indicator values is selected as the data receiving end;
wherein, in response to determining that the difference of any two of the plurality of received signal strength indicator values is greater than the second predetermined value, the emission power of the optical transmitter of the optical transceiver is increased.

14. The control method according to claim 13, wherein increasing the emission power of the optical transceiver is a relative adjustment that is performed when the difference of any two of the plurality of received signal strength indicator values is greater than the second predetermined value.

15. The control method according to claim 12, further comprising:
determining whether or not the optical transceiver identifies the data receiving end within a predetermined time; and
outputting, in response to the optical transceiver not identifying the data receiving end within the predetermined time, a warning signal.

16. The control method according to claim 15, wherein the warning signal is output to a server, such that the server records and analyzes a working status of the optical transceiver.

17. The control method according to claim 11, wherein a distance between each of the plurality of optical receivers and an optical transmitter of the optical transceiver is less than a distance between any two of the plurality of optical receivers.

18. The control method according to claim 17, wherein a quantity of the plurality of optical receivers is two, and the two optical receivers and the optical transmitter are arranged in a straight line.

19. The control method according to claim 17, wherein a quantity of the plurality of optical receivers is three, and the optical transmitter is positioned in a triangular area formed by the three optical receivers.
